(19) United States
(12) Patent Application Publication
(10) Pub. No.: US 2010/0208661 A1
(43) Pub. Date: Aug. 19, 2010

(54) METHOD, APPARATUS AND SYSTEM FOR A MOBILE STATION CELL SYSTEM

(76) Inventor: Rong Sun, Fremont, CA (US)

Correspondence Address: Rong Sun, 39521 Platero Place, Fremont, CA, 94539, US

(21) Appl. No.: 12/704,545

(22) Filed: Feb. 12, 2010

Related U.S. Application Data
(60) Provisional application No. 61/152,730, filed on Feb. 16, 2009.

(51) Int. Cl. H04W 72/04; H04W 16/00

(52) U.S. Cl. 370/328; 370/329

(57) ABSTRACT

This invention describes a method, apparatus and system for a mobile-station cell system, MSCell for short. An MSCell operates in a wireless network, more specifically in a cell of the wireless network. It interacts with the cell's BS the way a regular MS(s) do. The MSCell consists of an MSCell base and multiple MSCell terminals. The MSCell base simulates the regular MS(s) to set up one or more radio connections with the BS and simultaneously serves its own MSCell terminals. In other words, the MSCell behaves simultaneously as regular MS(s) to the BS and as the base to all its MSCell terminals. The MSCell terminals gain services from the wireless network through the MSCell base. The MSCell can also operate independently of any BS to be a self-contained standalone system where its MSCell terminals can call each other.

### TECHNICAL FIELD

The present disclosure relates generally to the field of mobile station system in a wireless network.

### BACKGROUND OF THE INVENTION

This invention relates generally to a wireless network, particularly to its radio access system, its subscriber profiles function and its call processing function. The radio access system consists of base stations and mobile stations which together provide wireless access to end users. The subscriber profiles function holds information for all subscribers of the wireless network, each subscriber having its own subscriber profile(s). A subscriber profile contains information about a subscriber, including but not limited to the subscriber's identifications, capability of the subscriber's mobile equipment, features subscribed, billing rate, current physical location, etc. Access initiated from or intended for a subscriber will be authenticated against its subscriber profile(s).

A wireless network serves certain geographical area, called service coverage. A wireless network's service coverage consists of a number of cells, each featuring a base station (BS). End users in a cell use their mobile stations (MS) to gain wireless access into the wireless network more specifically through the BS of the cell. In particular, a service provider operating a wireless system on a licensed frequency band typically has exclusive use of the licensed frequency band, such as GSM, UMTS, CDMA2000, and TD-SCDMA service providers. In such a wireless network, the service provider has a full control of radio transmission defined from BS(s). Others are only allowed to operate MS(s) to gain services from the wireless network.

### BRIEF DESCRIPTION OF THE DRAWINGS

FIG. 1 shows a simplified diagram of an exemplary wireless network in which the present invention operates.

### DETAILED DESCRIPTION

An MSCell 130 consists of an MSCell base 131 and multiple MSCell terminals 132. The MSCell base 131 may optionally have a built-in MSCell terminal. The connection L131 between the MSCell base 131 and each individual MSCell terminal 132 can be wired or wireless.

The MSCell base further consists of hardware and software. The hardware aspect contains CPU(s) (Central Processing Unit), memory e.g. RAM/ROM/FLASH/etc., crypto engine, console port(s), Ethernet port(s), broadband port(s), DSP (Digital Signal Processing), transceiver(s), PA (Power Amplifier), antennae, RTC (Real Time Clock), A/D (Analog/Digital Conversion), D/A (Digital/Analog Conversion), display e.g. LCD screen, keypad, buzzer, speaker, etc. The software resident in the memory and executed in the CPU(s) may be divided into subsystems such as physical layer containing functions for hardware control, modulation, channel coding, speech coding, etc., link layer, network layer, radio resource management, mobility management, call control processing, etc. Some of these functions may be optional for an MSCell base. The hardware and the software together implement all the control and algorithm logic needed for the MSCell base including but not limited to the functions specified by the system standards which the MSCell base acts upon. Such system standards include but are not limited to PHS, DECT, GSM, UMTS, CDMA2000, TD-SCDMA and WiMAX.

An MSCell terminal consists of hardware and software, too. Both hardware and software aspects contain functional elements similar to those needed for the MSCell base but may exclude functions such as Ethernet port(s) and broadband port(s). The MSCell terminal does not need to deal with the interface with the BS and may exclude relevant functions for this purpose. Each functional element for the MSCell terminal can be much less powerful in capacity in comparison with its peer function used for the MSCell base, since the MSCell terminal typically maintains just one call session with the MSCell base while the MSCell base needs to deal with multiple radio interfaces and maintains multiple call sessions with the BS and the MSCell terminals simultaneously. Thus MSCell base may have more powerful transceiver(s), more powerful CPU(s) and DSP(s) and larger memory. But a charger dock is usually an extra for an MSCell terminal since it is most likely battery operated.

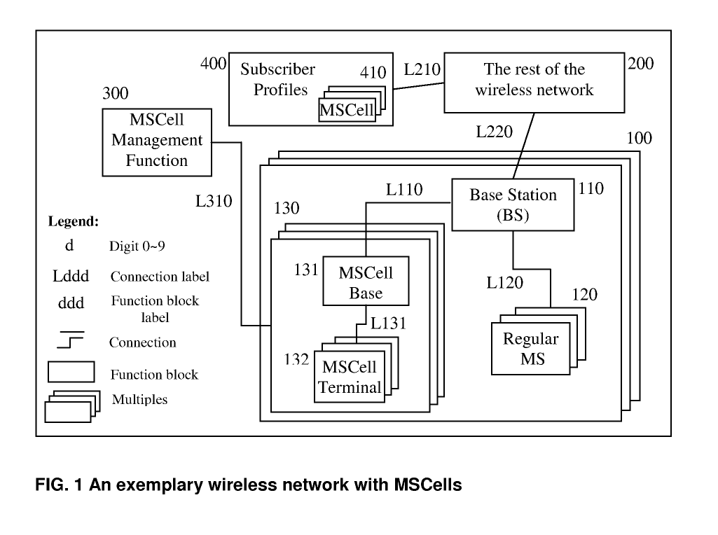

The MSCell 130 operates in a wireless network, more specifically in a cell 100 of the wireless network, shown in FIG. 1. It interacts with the cell's BS 110 the way the regular MS(s) 120 do. In detailed, the MSCell base 131 simulates the regular MS(s) 120 with respect to interaction with the BS 110 to set up radio connection(s) with the BS, but the MSCell base simultaneously serves its own MSCell terminals 132. In other words, the MSCell behaves simultaneously as regular MS(s) to the BS and as the base to all its MSCell terminals. The MSCell terminals gain services from the wireless network through the MSCell base.

The MSCell base 131 containing one or more radio transceivers is capable of simultaneously establishing and maintaining one or more radio connections with the BS and its own MSCell terminals. Such a radio connection may be set up on dedicated or shared radio resource(s). For example, a radio connection based on GSM for a phone call is based on dedicated radio resource, more specifically specific time slots on a given pair of frequencies, for downlink and uplink respectively. But a Wi-Fi based radio connection does not own any dedicated resource. All Wi-Fi radio stations contend for shared radio resource to transmit. If Wi-Fi is used in the MSCell, the MSCell base and each individual MSCell terminal will be Wi-Fi radio stations.

The MSCell base 131 allows its MSCell terminals to receive/make calls from/to users external to the MSCell and other MSCell terminals of its own. A call means a call session or an application session including but not limited to an audio only phone call, a video phone call, a gaming session, etc.

The MSCell 130 as a whole can have one or more main identifications (ID) e.g. main phone numbers and each individual MSCell terminal has its own unique extension ID and/or its own unique direct call ID. A user external to the MSCell can call the MSCell by any of its main IDs to reach the MSCell base which then routes the call to either the operator or the intended MSCell terminal(s) with help of the operator or directly by further using their extension ID. Each individual MSCell terminal can also be optionally reached by its own direct unique ID.

Another aspect of this MSCell invention includes a management function 300 which is used to manage MSCell(s) 130 including the MSCell base(s) 131 and terminals 132. Such a management function can be external to the MSCell base(s) and terminals or co-resident on either MSCell base(s) or MSCell terminal(s) or both. An external management function is connected to an MSCell via the console port(s) on its MSCell base and terminals or through the LAN or WAN according to data communication protocols e.g. the Internet Protocol (IP).

One advantage of the MSCell invention is that the MSCell plays the role of regular MS(s) to the BS instead of the role of the BS in terms of radio transmission. Thus, even when operating in a licensed frequency spectrum band, the MSCell does not need to get permission to operate in order to offer services to its MSCell terminals. One scenario of taking such an advantage is that the MSCell base operates on licensed bands to the BS side in order to get services from service providers operating GSM, UMTS, CDMA2000, TD-SCDMA, etc. and on unlicensed bands e.g. 2.4 GHz and 5 GHz to its own MSCell terminals in order to bridge services between the service providers and the MSCell terminals.

Another advantage of the MSCell invention is that an MSCell with a few terminals can be used as a home phone system. Such a phone system just needs an additional line added to a family cellular service plan to operate. An enhanced MSCell model for home use may allow two radio simultaneous connections with the BS, one dedicated to phone call and the other to fax.

Another advantage of the MSCell invention is that one or more MSCells can work together to form a phone systems for corporate use. These MSCells do not need to be in the same cell of a wireless network and in the same physical area, either. Each MSCell of this kind allows a number of simultaneous call sessions and/or radio connections between their MSCell base(s) and their BS(s).

One aspect of this MSCell invention is that an MSCell base can have built-in access point functions e.g. Wi-Fi access point(s) (AP) to simultaneously provide networking connection to mobile computing equipment e.g. laptop computers, PDAs, etc. The MSCell base is connected back-end into WAN (wide area network) via its broadband port(s) e.g. DSL, Cable, etc. or Ethernet port(s) e.g. Gigabit Ethernet. Thus, collectively the MSCell can provide both phone and data services to home and corporate users.

Another aspect of this MSCell invention is the registration procedure by which an MSCell 130 uses to complete its registration including both its MSCell base 131 registering itself on a BS of an expected wireless network as well as its MSCell terminals 132 registering on the MSCell base 131. The MSCell base and the MSCell terminals do not need to follow the same registration procedure for their respective registration. In fact, they most likely do different registration procedures. The registration procedure includes but is not limited to the procedures defined in various standards e.g. GSM Location Update procedure and ANSI-41 Registration procedure. Take GSM Location Update procedure as an example, in order for the MSCell base 131 to register on a BS of a GSM network, the MSCell base 131 behaves as a regular MS does. It first does power measurement on all predefined frequencies for the selected GSM frequency band(s) to short list the frequencies with sufficient transmission power levels. It then tries the short-listed frequencies one by one in descending order of transmission power level, starting from the strongest until it finds a proper one to camp on. For each frequency, the MSCell base 131 attempts to receive SCH/FCCH/BCCH bursts to first sync up its receiving and then decode System Information messages to decide if it is a good one to attempt a registering process. Following up, the MSCell base 131 performs the Location Update procedure to register itself on the network. For other standards, the MSCell base 131 performs the corresponding registration procedure specified for a regular MS of those standards accordingly. Take IEEE 802.11 standard as example, its association, re-association and disassociation procedures may constitute the required registration procedure.

Another aspect of this MSCell invention is the incoming call from external procedure by which an MSCell base 131 already registered on a wireless network abides to receive an incoming call from an external party to the MSCell and then route the call within the MSCell accordingly. In detailed, upon receiving an incoming call from external, for instance a Q.931 SETUP message or its variant for an incoming call, the MSCell base may optionally send back a progress-like message to the wireless network to indicate progression of the call, and simultaneously decide which MSCell terminal(s) should receive the call. The MSCell base will then ring the MSCell terminals intended for receiving the call. Internally, the MSCell base creates and maintains a call context for the call. The MSCell base also establishes the needed radio connections to the BS and the MSCell terminals intended in order to complete the call connection between the caller and the callee. Upon receiving a call control message from one side e.g. the BS, the MSCell base may need to regenerate the message of the same function toward the other side e.g. one intended MSCell terminal. The message regeneration as such deals with required call control protocol conversion from one system to another if two sides of the MSCell base are adopting different systems. The MSCell base may originate some call control messages itself e.g. a Q.931 Call Proceeding like message. The related call control messages include but are not limited to call setup message, call proceeding, progress, alerting, connect, connect acknowledgment, release, release complete, disconnect, etc. Other messages for radio resource management and mobility management also need to be handled wherever needed.

An MSCell terminal needs to be registered on the MSCell before it is allowed to receive an incoming call or initiate an outgoing call.

Another aspect of this MSCell invention is the outgoing call from MSCell terminals to external procedure by which an MSCell terminal already registered on the MSCell base can make a call to an external party through the MSCell base which is already registered on a BS of the wireless network. An external party means a party external to the MSCell. A dial tone can be optionally presented to the end user using the MSCell terminal for making a call. Such a dial tone can be generated either directly on the MSCell terminal itself or played down from the registered MSCell base. After finishing dialing the number, a call setup message or signal will be sent from the MSCell terminal to the MSCell base. The MSCell base then creates a call context for the call and generates a corresponding setup message sent to the BS the MSCell base is registered on. Optionally the MSCell base waits for a connect message from the called party. It may optionally receive other messages such as proceeding, progress, alerting, disconnect and release for the call. After the call is answered by the called party, the MSCell base connects the call to the calling MSCell terminal and start passing speech frames back and forth between the called party, precisely the BS, and the calling MSCell terminal.

Another aspect of this MSCell invention is the internal MSCell calling procedure by which registered MSCell terminals on the MSCell base abide to call each other. For this procedure, the MSCell base does not have to register on any BS of a wireless network. The MSCell itself is self-contained for such internal calls.

Another aspect of this MSCell invention is the call context. In detailed, the MSCell base 131 creates and maintains a call context for each call, regardless of internal or external and incoming or outgoing. When multiple calls exist simultaneously, each call has its own call context. After a call is torn down, its call context is removed. The call context of a call contains information about the call including but not limited to calling party number, called party number, and call state(s) such as alerting, connected, on hold, and being released. The contents of a call context might be organized into sub-contexts. For example, since a call comes inbound to the MSCell from one party and leaves outbound for outbound another party, the call context can be accordingly split into two sub-contexts, one containing information about the inbound side and the other about the outbound side.

Another aspect of this MSCell invention is the terminal profiles for MSCell terminals. In detailed, the MSCell base 131 creates and maintains a terminal profile for each MSCell terminal. The terminal profile for an MSCell terminal describes information about the MSCell terminal including but not limited to its registration state i.e. registered or unregistered, calling restriction e.g. international call restriction, supplementary call services capability such as call waiting, call holding, call transfer, multiparty call, caller ID, etc. The MSCell base refers to such terminal profiles to make decision in routing and processing calls. For example, if a terminal profile restricts international calling, the MSCell base will block all international call originated/terminated from/to the associated MSCell terminal.

Another aspect of this MSCell invention is the management function. In detailed, the management function is used to manage MSCell base(s) and MSCell terminals, including upgrading software, shutting down an MSCell base, adding/removing/provisioning an MSCell terminal profile, etc. The management function can be a built-in of an MSCell base or external to MSCells.

Another aspect of this MSCell invention is that one MSCell is able to optionally have multiple call IDs e.g. multiple main phone numbers. An external user can reach an MSCell with any of its IDs regardless of the number of simultaneous call sessions and/or radio connections allowed between the MSCell base and the BS on which the MSCell base is currently registered. Take GSM as example, an MSCell can operate on only one SIM card, only one IMSI short for International Mobile Subscriber Identity, and only one IMEI short for International Mobile Equipment Identity but one or more main call IDs which an external user use to call the MSCell. All calls from/to the MSCell with use of any of its call IDs share the same IMSI and IMEI wherever required. But certainly an MSCell can carry more than one SIM cards.

Another aspect of this MSCell invention is the subscriber profile(s) for MSCells 410. Each MSCell has a subscriber profile in the wireless network the MSCell subscribes to. All calls from/to an MSCell will be handled in the related wireless network(s) with reference to its subscriber profile. The subscriber profile for an MSCell holds the same information as that for a regular MS as well as some MSCell-specific information optionally. In the case that an MSCell's subscriber profile does not have any MSCell-specific information, the wireless network may not be able to tell any difference between the MSCell and a regular MS. The optional MSCell specific information includes but is not limited to how many simultaneous call sessions and/or radio connections are allowed between the MSCell and the BS on which the MSCell is currently registered, main call IDs for the MSCell, etc. Here radio connections are used to carry call sessions between the MSCell and the BS. Typically one radio connection carries on one call session.

Another aspect of this MSCell invention is the multiple simultaneous call procedure by which an MSCell abides to set up multiple calls with the wireless network simultaneously, more specifically with the BS on which it is currently registered. In detailed, when one MSCell terminal, say A, is on a call with an external party, another MSCell terminal, say B, can receive/make an additional external call as follows:

Firstly, the subscriber profile of the MSCell will be provisioned to allow multiple call sessions and/or radio connections with BS on which it is registered. Assuming an additional radio connection is still allowed between the MSCell and the BS with reference to the subscriber profile of the MSCell. Then when the MSCell initiates a radio connection with the BS on behalf of B, the radio connection will be set up over which the call to/from B will be established. As long as the number of call sessions and/or radio connections the MSCell has with the wireless network is still less than the allowed number of call sessions and/or radio connections for the MSCell, the call process for B can be reproduced for another MSCell terminal say C to establish an additional call session, and so on.

Another aspect of this MSCell invention is the supplementary features capability the MSCell has as well as the related procedures for these features such as call waiting, call holding, and call barring. These features are related or independent of the features of the kind offered by the wireless network the MSCell is currently registered on.

Even some description of this MSCell invention has been using GSM and Wi-Fi to elaborate some details, the description itself is generally applicable to other standards including but not limited to PHS, DECT, UMTS, CDMA2000, TD-SCDMA and WiMAX.

Other aspects, advantages, features of this invention will be clear from description herein.

I claim:

1. A method for designing a mobile-station cell system (MSCell) in a wireless environment, said MSCell consisting of a MSCell base unit (MSCell base) plus one or more MSCell terminals, said wireless environment including one or more wireless networks, said method comprising:
said MSCell base functioning as one or more mobile stations to communicate with said one or more wireless networks; and
said MSCell base functioning as base to serve said one or more MSCell terminals.

2. The method of claim 1, wherein said MSCell base functioning as one or more mobile stations to communicate with said one or more wireless networks further comprises:
said one or more wireless networks operating according to the same system standard including the operating frequency band(s) defined in said standard; and
said one or more wireless networks operating according to two or more different system standards including the operating frequency band(s) defined in said standards; and
said MSCell base communicating with said one or more wireless networks in accordance with the system standard(s) adopted by said one or more wireless networks.

3. The method of claim 2, wherein said MSCell base communicating with said one or more wireless networks in accordance with the system standard(s) adopted by said one or more wireless networks further comprises:
performing registration procedures with said one or more wireless networks; and
performing mobile originating call procedures with said one or more wireless networks; and
performing mobile terminating call procedures with said one or more wireless networks; and
performing call independent supplementary services procedures such as call forwarding and call barring with said one or more wireless networks; and
performing call related supplementary services procedures such as call waiting, call conferencing, and call holding with said one or more wireless networks.

4. The method of claim 3, wherein said call comprises a multimedia call, said multimedia comprising voice, video, fax and data.

5. The method of claim 1, wherein said MSCell base functioning as base to serve said one or more MSCell terminals comprises:
said one or more MSCell terminals registering on said MSCell base to become callable, said callable meaning able to make and receive calls through said MSCell base; and
said MSCell base functioning as exchange to connect calls among said one or more MSCell terminals and/or said one or more wireless networks said MSCell base is currently registered with.

6. The method of claim 5, wherein said MSCell base functioning as exchange to connect calls among said one or more MSCell terminals and/or said one or more wireless networks said MSCell base is currently registered with further comprises:
said MSCell base routing calls from said one or more wireless networks to said one or more MSCell terminals; and
said MSCell base routing calls from said one or more MSCell terminals into said one or more wireless networks; and
said MSCell base routing calls among said one or more MSCell terminals; and
said MSCell base routing calls from said one or more MSCell terminals to other said one or more MSCell terminals as well as into said one or more wireless networks.

7. The method of claim 6, wherein said calls comprise multimedia calls, said multimedia comprising voice, video, fax and data.

8. The method of claim 6, wherein said MSCell base routing calls from said one or more wireless networks to said one or more MSCell terminals further comprises performing the incoming call from external procedure for each individual call, said procedure comprising:
establishing one or more network radio connections between said MSCell base and the initiating wireless network which initiates said individual call, over said one or more network radio connections said MSCell base and said initiating wireless network exchanging messages; and
said initiating wireless network sending a call setup message to said MSCell base; and
said MSCell base receiving said call setup message; and
said MSCell base analyzing said call setup message and responding with a call setup acknowledgement message to said initiating wireless network;
said MSCell base determining the terminating MSCell terminal(s) to receive said individual call; and
establishing one or more terminal radio connections between said MSCell base and said terminating MSCell terminal(s), over said one or more terminal radio connections said MSCell base and said terminating MSCell terminal(s) exchanging messages; and
said MSCell base sending terminal call setup message(s) to said terminating MSCell terminal(s), said terminal call setup message(s) corresponding to said call setup message received from said initiating wireless network and conforming to the system standard adopted for communication between said MSCell base and said terminating MSCell terminal(s); and
said terminating MSCell terminal(s) receiving said terminal call setup message(s) from said MSCell base and ringing; and
said terminating MSCell terminal(s) answering said individual call and sending terminal call connect message(s) to said MSCell base; and
said MSCell base receiving said terminal call connect message(s) from said terminating MSCell terminal(s) answering said individual call; and
said MSCell base sending a call connect message to said initiating wireless network; said call connect message corresponding to said terminal call connect message(s) and conforming to the system standard adopted by said initiating wireless network; and
said MSCell base connecting said initiating wireless network and said terminating MSCell terminal(s) to establish end to end communication between the caller and the callee(s); and
tearing down said individual call when said individual call is ended by the caller and/or the callee(s) or said individual call cannot proceed.

9. The method of claim 6, wherein said MSCell base routing calls from said one or more MSCell terminals into said one or more wireless networks comprises performing the outgoing call from MSCell terminals to external procedure for each individual call, said procedure comprising:
establishing one or more terminal radio connections between said MSCell base and the initiating MSCell terminal which initiates said individual call, over said one or more terminal radio connections said initiating MSCell terminal and said MSCell base exchanging messages; and
said initiating MSCell terminal sending a terminal call setup message to said MSCell base; and
said MSCell base receiving said terminal call setup message from said initiating MSCell terminal; and
said MSCell base analyzing said terminal call setup message and responding with a terminal call setup acknowledgement message to said initiating MSCell terminal; and
said MSCell base determining the terminating wireless network(s) to receive said individual call; and
establishing one or more network radio connections between said MSCell base and said terminating wireless network(s), over said network radio connections said MSCell base and said terminating wireless network(s) exchanging messages; and
said MSCell base sending call setup message(s) to said terminating wireless network(s) to reach the callee(s), said call setup message(s) corresponding to said terminal call setup message and conforming to the system standard(s) adopted by said terminating wireless network(s); and
said MSCell base receiving call connect message(s) from said terminating wireless network(s) through which said individual call was answered; and
said MSCell base sending a terminal call connect message to said initiating MSCell terminal, said terminal call connect message corresponding to said call connect message(s) and conforming to the system standard adopted for communication between said MSCell base and said initiating MSCell terminal; and
said MSCell base connecting said terminating wireless network(s) through which said individual call was answered and said initiating MSCell terminal to set up end to end communication between the caller and the callee(s); and
tearing down said individual call when said individual call is ended by the caller and/or the callee(s) or said individual call cannot proceed.

10. The method of claim 6, wherein said MSCell base routing calls among said one or more MSCell terminals further comprises performing the internal MSCell calling procedure for each individual call, said procedure comprising:
establishing one or more originating terminal radio connections between the initiating MSCell terminal which initiates said individual call and said MSCell base, over said one or more originating terminal radio connections said initiating MSCell terminal and said MSCell base exchanging messages; and
said initiating MSCell terminal sending a originating terminal call setup message to said MSCell base; and
said MSCell base receiving said originating terminal call setup message from said initiating MSCell terminal; and
said MSCell base analyzing received said originating terminal call setup message, responding accordingly with a terminal call setup acknowledgement message to said initiating MSCell terminal and determining the terminating MSCell terminal(s) to receive said individual call; and
establishing one or more terminating terminal radio connections between said MSCell base and said terminating MSCell terminal(s) for said individual call, over said one or more terminating terminal radio connections said MSCell base and said terminating MSCell terminal(s) exchanging messages; and
said MSCell base sending terminating terminal call setup message(s) corresponding to said originating terminal call setup message received from said initiating MSCell terminal to said terminating MSCell terminal(s); and
said terminating MSCell terminal(s) receiving said terminating terminal call setup message(s) from said MSCell base and ringing; and
said terminating MSCell terminal(s) answering said individual call; and
said MSCell base receiving terminating terminal call connect message(s) from
said terminating MSCell terminal(s) answering said individual call; and
said MSCell base sending an originating terminal call connect message to said initiating MSCell terminal; and
said MSCell base connecting said initiating MSCell terminal and said terminating MSCell terminal(s) answering said individual call to set up end to end communication between the caller and the callee(s); and
tearing down said individual call when said individual call is ended by the caller and/or the callee(s) or said individual call cannot proceed.

11. The method of claim 6, wherein said MSCell base routing calls from said one or more MSCell terminals to other said one or more MSCell terminals as well as into said one or more wireless networks further comprises performing a mixed outgoing call procedure, said procedure comprising:
establishing one or more originating terminal radio connections between the initiating MSCell terminal which initiates said individual call and said MSCell base, over said one or more originating terminal radio connections said initiating MSCell terminal and said MSCell base exchanging messages; and
said initiating MSCell terminal sending a originating terminal call setup message to said MSCell base; and
said MSCell base receiving said originating terminal call setup message from said initiating MSCell terminal; and
said MSCell base analyzing received said originating terminal call setup message, responding accordingly with a terminal call setup acknowledgement message to said initiating MSCell terminal; and
said MSCell base determining both terminating MSCell terminal(s) and terminating wireless network(s) to receive said individual call; and
establishing one or more terminating terminal radio connections between said MSCell base and said terminating MSCell terminal(s) for said individual call, over said one or more terminating terminal radio connections said MSCell base and said terminating MSCell terminal(s) exchanging messages; and
establishing one or more network radio connections between said MSCell base and said terminating wireless network(s) for said individual call, over said one or more network radio connections said MSCell base and said terminating wireless network(s) exchanging messages; and
said MSCell base sending terminating terminal call setup message(s) to said terminating MSCell terminal(s) and network call setup message(s) to said terminating wireless network(s), said terminating terminal call setup message(s) and said network call setup message(s) corresponding to said originating terminal call setup message received from said initiating MSCell terminal; and
said terminating MSCell terminal(s) receiving said terminating terminal call setup message(s) from said MSCell base and ringing; and
answering said individual call through said terminating MSCell terminal(s) and/or terminating wireless network(s); and
said MSCell base receiving terminating terminal call connect message(s) from said terminating MSCell terminal(s) and/or network call connect message(s) from said terminating wireless network(s); and
said MSCell base connecting said initiating MSCell terminal, said terminating MSCell terminal(s) and said wireless network(s) through which said individual call was answered to set up end to end communication between the caller and the callee(s); and
tearing down said individual call when said individual call is ended by the caller and/or the callee(s) or said individual call cannot proceed.

12. The method of claim 6 further comprises:
said MSCell base creating and maintaining a call context for each individual call, said call context containing information about said individual call including call state, call type, calling party number, called party number, the MSCell terminal(s) involved, and the wireless network(s) involved.
removing the call context for an individual call as part of the process of tearing down said individual call; and
splitting the call context for an individual call to two or more sub-contexts, each sub-context containing call information about a call segment of said individual call, said call segment consisting of two ends with said MSCell base as one end and one involved MSCell terminal or wireless network as the other end.

13. The method of claim 1, wherein said MSCell base functioning as one or more mobile stations to communicate with said one or more wireless networks further comprises:
one or more said more mobile stations each having its own subscriber profile with its subscribed wireless network; and
two or more said mobile stations sharing one subscriber profile with their subscribed wireless network, each mobile station having its own unique identity, said identity contained in the shared subscriber profile.

14. The method of claim 1 further comprises two or more said MSCell systems interconnecting to form a multi-MSCell system, said multi-MSCell system comprising:
a MSCell terminal of said multi-MSCell system registering with any of its MSCell base units of said multi-MSCell system to get registered with said multi-MSCell system; and
a MSCell terminal of said multi-MSCell system making/receiving calls to/from the MSCell base said MSCell terminal is registered with; and
a MSCell terminal engaged in a call continuing said call while said MSCell terminal crossing from coverage of one MSCell to coverage of another MSCell in said multi-MSCell system, said another MSCell continuing serving said call.

15. The method of claim 14 further comprises a management function for managing said multi-MSCell system, said management function comprising:
configuring the MSCell base units and MSCell terminals of said multi-MSCell system; and
upgrading software embedded in the MSCell base units and MSCell terminals of said multi-MSCell system; and
storing data for said multi-MSCell system, said data made accessible to the MSCell base units and MSCell terminals of said multi-MSCell system.

16. A mobile station cell system(MSCell) base unit (MSCell base) that serves one or more mobile station cell system terminals (MSCell terminals) comprises:
circuitry configured to function as one or more mobile stations to communicate with one or more wireless networks; and
circuitry configured to function as base to serve one or more MSCell terminals.

17. The MSCell base of claim 16 further comprises:
circuitry configured to receive network radio bursts from said one or more wireless networks in accordance with the system standard(s) adopted by said one or more wireless networks, including operating frequency band(s) defined in said standard(s); and
circuitry configured to transmit network radio bursts to said one or more wireless networks in accordance with the system standard(s) adopted by said one or more wireless networks, including operating frequency band(s) defined in said standard(s).
circuitry configured to receive terminal radio bursts from said one or more MSCell terminals in accordance with one or more terminal system standards selected as communication protocols between said MSCell base and said one or more MSCell terminals, including operating frequency band(s) defined in said standards; and
circuitry configured to transmit terminal radio bursts to said one or more MSCell terminals in accordance with one or more terminal system standards selected as communication protocols between said MSCell base and said one or more MSCell terminals, including operating frequency band(s) defined in said standards and
circuitry configured to keep broadcasting information about said MSCell base based on which said MSCell terminals knowing existence of said MSCell base.

18. The MSCell base of claim 16, wherein circuitry configured to function as one or more mobile stations to communicate with one or more wireless networks further comprises:
circuitry configured to receive/transmit one or more radio bursts from/to said one or more wireless networks to perform registration procedures in accordance with the system standard(s) adopted by said one or more wireless networks, including operating frequency band(s) defined in said standard(s); and
circuitry configured to receive/transmit one or more radio bursts from/to said one or more wireless networks to perform mobile originating call procedures in accordance with the system standard(s) adopted by said one or more wireless networks, including operating frequency band(s) defined in said standard(s); and
circuitry configured to receive/transmit one or more radio bursts from/to said one or more wireless networks to perform mobile terminating call procedures in accordance with the system standard(s) adopted by said one or more wireless networks, including operating frequency band(s) defined in said standard(s) ; and
circuitry configured to receive/transmit one or more radio bursts from/to said one or more wireless networks to perform call independent supplementary services procedures such as call forwarding and call barring in accordance with the system standard(s) adopted by said one or more wireless networks, including operating frequency band(s) defined in said standard(s); and
circuitry configured to receive/transmit one or more radio bursts from/to said one or more wireless networks to perform call related supplementary services procedures such as call waiting, call conferencing, and call holding in accordance with the system standard(s) adopted by said one or more wireless networks, including operating frequency band(s) defined in said standard(s).

19. The MSCell base of claim 16, wherein circuitry configured to function as base to serve one or more MSCell terminals comprises
circuitry configured to function as exchange to connect calls among said one or more MSCell terminals and/or one or more wireless networks said MSCell base is registered with.

20. The MSCell base of claim 19, wherein circuitry configured to function as exchange to connect calls among said one or more MSCell terminals and/or one or more wireless networks further comprises:
circuitry configured to route calls from said one or more wireless networks to said one or more MSCell terminals; and
circuitry configured to route calls from said one or more MSCell terminals into said one or more wireless networks; and
circuitry configured to route calls among said MSCell terminals; and
circuitry configured to route calls from said one or more MSCell terminals to other said one or more MSCell terminals as well as into said one or more wireless networks.

21. A mobile station cell system terminal unit (MSCell terminal) that connects to one or more mobile station cell system base units over one or more wireless connections, said MSCell terminal comprising:
circuitry configured to receive/transmit radio bursts from/to said one or more base units according to one or more system standards including the frequency band(s) defined in said standards; and
circuitry configured to receive/transmit radio bursts from/to a selected base unit from said one or more base units to perform registration with said selected base unit; and
circuitry configured to receive/transmit radio bursts from/to a selected base unit from said one or more base units to make and receive calls through said selected base unit.
